(19) United States
(12) Patent Application Publication
(10) Pub. No.: US 2021/0027357 A1
(43) Pub. Date: Jan. 28, 2021

(54) SYSTEMS AND METHODS FOR CREDIT CARD SELECTION BASED ON A CONSUMER'S PERSONAL SPENDING

(71) Applicants: Michael Bonfigli, New York, NY (US); Kevin Cash, Brooklyn, NY (US)

(72) Inventors: Michael Bonfigli, New York, NY (US); Kevin Cash, Brooklyn, NY (US)

(21) Appl. No.: 17/043,335

(22) PCT Filed: Apr. 2, 2019
(86) PCT No.: PCT/US2019/025351

§ 371 Date: Sep. 29, 2020

Related U.S. Application Data
(60) Provisional application No. 62/651,947, filed on Apr. 3, 2018.

(51) Int. Cl. G06Q 30/06; G06Q 20/34; G06Q 40/02

(52) U.S. Cl. CPC G06Q 30/0631; G06Q 20/355; G06Q 30/0627; G06Q 30/0621; G06Q 40/025

(57) ABSTRACT

The present disclosure provides systems and methods for credit card selection based on personal spending. For example, one or more transaction histories can be accessed and a plurality of transactions can be retrieved or obtained therefrom. Credit card recommendations then can be determined based at least in part on the retrieved plurality of transactions. Other aspects also are described.

### CROSS-REFERENCE TO RELATED APPLICATION

The present application claims the benefit of U.S. Provisional Patent Application 62/651,947, which was filed Apr. 3, 2018.

### INCORPORATION BY REFERENCE

U.S. Provisional Patent Application No. 62/651,947, which was filed Apr. 3, 2018, is hereby incorporated by reference for all purposes as if presented herein its entirety.

### TECHNICAL FIELD

The present disclosure is directed to systems and methods for credit card section, in particular, systems and methods for matching credit card selection or credit card recommendations based on a user's/consumer's personal spending.

### BACKGROUND

Finding and selecting a credit card that provides the best amount of rewards points for a user can be a very difficult and time intensive process. Traditionally, some companies have tried to implement quiz/questionnaire-based approaches to make general guesses about a user's spending history based on their answers to provide personalized recommendations, Such questionnaire based solutions may not provide the optimal rewards credit card options, however, because a user may not accurately recall or answer questions regarding their personal spending history/habits, and a user's spending habits/trends may vary greatly over time. Accordingly, it can be seen that a need exists for systems and methods that employ a user's actual spending/transaction information history to provide recommendations for credit card rewards programs in an automated manner. The present disclosure addresses these and other related, and unrelated, problems in the art.

### SUMMARY

Briefly described, the present disclosure includes a system for determining and matching maximum possible value credit card rewards and/or credit cards for a user.

The system can include one or more processors, and a memory having stored therein a plurality of instructions that, when executed by the one or more processors, implement a transaction aggregator and a credit card recommendation engine. The transaction aggregator can be configured to retrieve or otherwise access a transaction history of the user (e.g., from one or more user selected financial institutions). The credit card recommendation engine can be configured to receive the transaction history from the transaction aggregator and determine a rewards value for one or more credit cards based at least in part on the retrieved user transaction history and predefined categories.

For example, the credit card recommendation engine can be configured to filter transactions from the transaction history into filtered transactions based on the predefined categories, and then match the filtered transactions with credit card reward terms of one or more credit cards to determine a rewards value (e.g., a standardized cash value) for the one or more credit cards or to determine recommendations of one or more cards or combination of cards. Further, the credit card recommendation engines can employ machine learning (e.g., by applying machine learning algorithms, neural networks, or other supervised learning algorithms) to generate a rewards value, card recommendations, etc.

The system can aggregate information regarding a user's transaction history and/or past historical expenditures from the user's credit card, bank, shopping, and/or other statements indicative of purchasing or spending history of the user, and apply categories, e.g., based on Merchant Category Codes (MCCs), from point-of-sale to the aggregated transactions for comparing with the existing cash value rewards returned by known credit cards.

Generally, credit card rewards programs structured around MCCs, which merchants typically assign to themselves when signing up point-of-sale or point-of-purchase terminals. More specifically, point-of-sale networks generally require participating merchants to self-assign MCCs classifying what products the merchants sell or what services the merchants offer. The system can account for Network-specific MCCs by accessing and obtaining information from credit card provider (e.g., MasterCard®, VISA®, etc.) application programming interfaces (APIs) using system-normalized merchant data sourced from user transactions.

The system can determine and provide a cash value recommendation and supporting analysis of the rewards that could have been earned with a plurality of credit cards based on the user's transaction or personal spending history. For example, based on the analyzed data, the system can provide the user with a combination of credit cards that could have earned the individual a maximum cash value reward. The system further can provide a standardized rewards value for a card or cards that includes a total dollar amount saved/earned by the credit card.

In operation, the system may connect to/communicate with a third-party financial aggregator or other suitable API to return a user's transaction data. However, the system can aggregative the user's transaction data, itself, without departing from the scope of the present disclosure.

Users may grant the system access to their spending histories via a third-party financial aggregating service by logging in with their credentials Users also may employ other, alternative means for providing transaction history data, such as uploading monthly statements or spreadsheet listings of transactions over time.

The system further play group or filter transactions into categories that pertain to or otherwise relate to MCCs. Incomplete third-party data further can be generally reconciled with additional API connectors to credit service providers, such as VISA® and MasterCard®, for normalizing and helping to increase accuracy of the merchant data.

Background calculations may be run on a selected historical me period, e.g., for up two years' worth of spending transaction and recommendation logic, to determine the maximum possible points or potential value for each of the credit cards. Values can be limited to how much a user naturally spends so as to personalize recommendations for the user to show them the true value of the points/rewards.

The system further can match the categorized/filtered rewards values with various known/available credit cards reward programs terms to determine the maximum possible rewards points or potential value for a plurality of credit cards. Available credit cards for matching may be selected by a user or provided based on a user's likelihood of approval.

The system also may translate the rewards points or other varying, non-cash benefits of the plurality of cards into an actual dollar value to standardize all rewards between selected cards.

The system further can output an analysis or comparison of relevant information to the user, which can include a total rash value rewards including all positive cash value, such as points and redemption multiples, and netting those values with negative cash values, such as fees, service charges, etc., to provide the user with as full a picture as possible to select their maximum rewards card or combination of cards.

In one example, the user in be directed to a page(s) or pop-up screen(s) for one or more credit cards with the maximum calculated cash value rewards. The user can have the option to view every available credit card and the corresponding cash value earnings for each credit card. The user also can click through and apply for each credit card, or can access more relevant details/analysis explaining the reasoning behind each card's value as it pertains to the user's personal spending.

Rewards calculations further can include, but are not limited to, cash-back categories, cash-back caps, cash-back earnings, timed earned windows, fees, sign-up promotions, sign-up bonuses, bonus requirements, annual credits, redemption multipliers rotating categories, interest rates, promotional interest rates, airline miles, and/or other suitable information or combinations thereof.

A method for credit card(s) selection or credit card(s) recommendations based upon a user's personal spending can be provided in accordance with the present disclosure.

The method can include receiving a request for personalized credit card recommendations from a user, for example, a user who accesses a system interface, e.g., logs in using secured credentials, verification, etc.

Upon receipt of this user request, a determination can be made as to whether the user has granted access to the user's transaction history data from the user's banking, credit, shopping and/or other financial service providers, for example, by providing and/or inputting the user's access credentials to each identified or selected provider via the system interface, uploading statements, etc.

If the user has not granted access their transaction history data, the user may be prompted to grant access to one or more of the user's financial service providers. If the used grants access to their selected financial service providers, the system can then request access to the user's transaction data history from each of the authorized financial service providers.

Thereafter, a series of transactions can be retrieved from the accessed transaction data history. The user further may be allowed to select and/or exclude specific transactions for analysis, for example, transactions that occurred over a specific time period, transactions of a specific type, etc.

Subsequently, a determination can be made as to whether the selected transactions correspond to predefined or generated categories developed to generally relate to known or defined categories or groupings of merchants. For example, the categories can be generated by a third-party service provider, based on predefined codes or definitions (e.g., such as MCCs generated by merchants to define their goods and/or services for point of sale transactions), and/or based on merchant information received from a credit card company developer network.

If the selected transactions do not match any predefined or generated categories, one or more additional categories can be generated based upon known information. For example, transactions may be categorized using statistical analysis, probabilistic modeling, machine learning, etc. If no categories would be appropriate (e.g., the transaction(s) is not of the type that credit card companies recognize for rewards points), the transactions can be discarded.

The transactions then can be filtered into the predefined or generated categories. The filtered transactions can be matched with credit card reward terms for a plurality of credit cards to determine a total rewards value for each credit card of the plurality of credit cards, Additionally, certain cards may not relate to a given user based on factors, such as credit-worthiness or membership restrictions set by cardholder agreements. These qualifiers may be taken into account based on information the user provides before and/or after credit card rewards values are displayed, to further filter the set of credit cards shown to a given person. The qualifiers may be manually collected data points or generated automatically when using third party software to help project a user's credit worthiness.

The total rewards value further can be standardized for each credit card of the plurality of credit cards. For example, rewards points for each credit card may be standardized into an actual cash value with, for example, the cost or fees of the credit card being subtracted from its cash value.

Thereafter, the method can include displaying selectable results including a listing or other grouping of each credit card or combinations of credit cards and their corresponding standardized rewards value to allow a user to compare the rewards cards and also select specific rewards cards or combinations, thereof. Furthermore, the method allows for manual adjustments to variables that a user might want to change based on anticipated spending habits that were not apparent in historical transaction data. These variables could include, but are not limited to: one-off rewards, such as bonuses, time horizon(s) for card usage, total desired number of credit cards to be held in a wallet, etc.

Upon receipt of a selected result, a user can be directed to a website, fillable form, etc., to allow the user to apply for the selected credit card(s). The method further can include machine learning to determine the numeric value, make card recommendations, etc.

Various objects, features and advantages of the present disclosure will become apparent to those skilled in the art upon a review of the following detail description, when taken in conjunction with the accompanying drawings.

### BRIEF DESCRIPTION OF THE DRAWINGS

It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 shows a schematic representation of a system for matching credit card select based on a user's personal spending according to principles of the present disclosure.

FIGS. 2A and 2B show a flow diagram for a method or process for matching credit card selection based on a user's personal spending according to principles of the present disclosure.

FIG. 3 show a timeline of a sequence of events according to principles of the present disclosure.

FIG. 4 shows a flow diagram for a process for matching credit card selection based on a consumer's personal spending according to principles of the present disclosure.

FIG. 5 shows a flow diagram for a process for matching credit card selection based on a consumer's personal spending according to principles of the present disclosure.

FIGS. 6A & B show diagrams for training and prediction of a credit card recommendation engine including machine learning according to principles of the present disclosure.

FIG. 7 shows a process flow diagram for analyzing use a and matching credit cards according to principles of the present disclosure.

FIG. 8 shows a diagram for rewards standardization in accordance with principles of the present disclosure.

FIG. 9 shows a process flow diagram for a third party browser extension or embeddable tool according to principles of the present disclosure.

FIG. 10 shows an exemplary screen of an application or program for the systems/methods of the present disclosure.

FIG. 11 shows an exemplary screen of an application or program for the systems/methods of the present disclosure.

The use of the same reference symbols in different drawings indicates similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

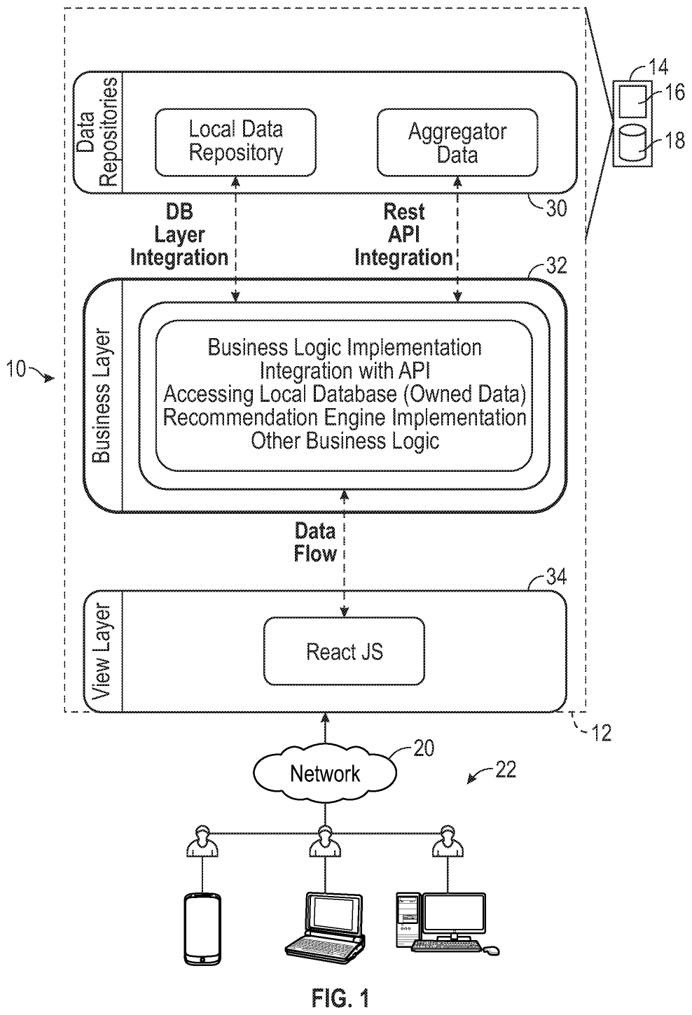

The present disclosure des a system 10 (FIG. 1) with a computer implemented product(s), engine(s), platform(s), etc. 12 that extracts information from financial transactions, such as merchant name, merchant category, dollars spent, etc. and then can calculate a cash value conversion for each of a given credit card spending rewards programs and/or provide a recommended card or combination of recommended cards. For example, recommendations of credit cards for a user on a personalized one-to-one basis, by matching the extracted spaced data with propriety databases or variables that define credit card rewards in the marketplace to calculate specific individual recommendation results (e.g., a reward's value, a recommended credit card, a group of recommended credit cards, etc.) for each user.

FIG. 1 is a schematic block diagram of the system 10 according to principles of the present disclosure. As shown in FIG. 1, the computer implemented product or program 12 can be resident on or accessed by one or more devices 14, such as a server, CPU, or other suitable computing device, for example, that can be part of a data center managed by a service provider. The computing device 14 can include at least one processor 16, such as a central processing unit (CPU) or hardware or software control logic, ROM, and/or other types of nonvolatile memory, and at least one storage or memory 18, such as random access memory (RAM) or (ROM). The device 14 further may include one or more ports for communicating with external devices and various input and output (I/O) devices, such as a keyboard, a mouse, touchscreen and/or a video display (not shown).

One or more components of the product 12 can be stored on the memory 18 and accessed and/or executed by the processor 16; however, one or more components of the product 12 can be stored and/or accessed from other memories and/or storages in communication with the computing device 14.

The system further can include a network 20, e.g., the internee or other suitable public or private network, that can be accessible to/by one or more user managed systems or devices 22 to facilitate communication and access between users and the product 12.

The user managed systems/devices 22 can include handheld mobile devices, such as mobile phones, Smart phones, tablets, PDAs, as well as laptops, desktops, work stations, or other suitable computing devices, and can be connected to the network 20 through wired connections, e.g., an Ethernet cable, or other suitable wired or wireless connections 18, e.g., WiFi, Bluetooth®, cellular connections (e.g., 3G, 4G, LTE, 5G, etc.), other suitable wireless connections or combinations thereof (FIG. 1), to enable users to communicate with and access the platform or program 12. The user managed devices 22 may include any suitable device operable to compute, calculate, determine, classify, process, transmit, receive, retrieve, originate, switch, store, display, communicate, manifest, detect, record, reproduce, handle, or utilize any form of information, intelligence, or data for any suitable purpose. The devices 22 may include a storage, such as random access memory (RAM) or (ROM), one or more processing resources such as a central processing unit (CPU) or hardware or software control logic, ROM, and/or other types of nonvolatile memory. The devices 22 further may include one or more ports and/or antennas (e.g., RF, Bluetooth®, etc.) for communicating with eternal devices and various input and output (I/O) devices, such as a keyboard, a mouse, touchscreen and/or a video display.

In one example, the product 12 can include one or more web-based applications that utilize/implement React JS or other suitable front end technologies. However, the product 12 can otherwise be accessed through the network 20, or the product 12 or one or more components thereof can be loaded to a user's managed device 22, e.g., as a mobile application, software program, etc., without departing from the present disclosure.

In addition, in the alternative, the product 12 can include a browser extension or embeddable tool (e.g., that interfaces with a web browser, such as Google Chrome®, Mozilla Firefox®, Microsoft Internet Explorer®, etc.). The embeddable tool can be placed/displayed on a third-party site for external use. Similarly, the browser extension can enable scraping or other information gathering from third-party websites, e.g., such that as a user is shopping for products, services, etc., and the system can provide information about the most suitable credit cards on the market for any particular purchase, as well as information on which of the user's current cards are most suitable for particular purchases.

Furthermore, n additional or alternative variations, the product 12 can include one or more components, modules, etc. that interface or otherwise communicate with APIs of financial services providers (e.g., banks, credit card companies, other financial technology (“fintech”) companies, etc.) to run over transactions their customers, thereby allowing the financial service providers to make use of the system with their own user transaction data, e.g., to determine a customer's suitability for a particular credit card(s), for recommending credit card(s) to customers, etc.

As further shown in FIG. 1, the system 10 can include a plurality of layers or components 30, 32, 34, operable for credit card selection/recommendation, for example, by aggregating information about past historical expenditures from previous credit card, bank, or shopping statements or other financial transaction information, and using categories relating to merchant category codes (MCCs) from point of sale and/or other rewards provided by credit card companies (e.g., cash back for shopping with select merchants) for comparing with the existing cash value rewards returned.

MCCs generally are developed, assigned, selected, etc. by merchants, themselves, to classify the products or services they provided, e.g., when signing up for point-of-sale or point-of-purchase terminal networks. For example, point-of-sale networks generally require participating merchants to determine and self-assign MCCs classifying the types of products they sell or the types of services they offer.

In one example, as shown in FIG. 1, the system 10 can include one or more data repositories 30 that store different data sets, e.g., local data 300 and aggregated data 301. The system 10 further can include a business layer 32 operable to integrate with APIs, access local databases, etc. and with one or more engine e.g., recommendation engines 302, or other business logic, workflows, etc. In addition, the system 10 can include a view layer 34 with a user interface 303 (for example, developed using React JS or other suitable interface developer) that allows a user to access and control the system 10 using the devices 22, e.g., to view, select, compare, and filter results.

The business layer 32 can access a user's transaction history from the user's selected credit card, banking, shopping and/or other financial service provider, and further can aggregate transactions and store them in the aggregator data repositories 301.

From the aggregated data, the recommendation engine 302 can determine the cash value of the possible rewards earned with selected cards, e.g., by cross-referencing a proprietary data store, such as in local data store 300, to determine which credit cards could have earned more.

The proprietary data store 300 can include data that relates to one or more merchant category codes used to assign rewards points/values to transactions based on credit card rewards terms, and/or can include information relating to offers, e.g., cash back offers, provided by specific cards, for example, with participating/select merchants (e.g., specific cards may offer a certain percentage of cash back for purchases with various merchants, e.g., online retailers, hotels, grocery stores, gas stations, etc.).

Credit card rewards terms further can include, but are not limited to, cash back earnings categories, cash redemption, categories (and multipliers for specified spend), merchant earnings categories, merchant redemption categories, cash back caps (maximums), cash back time frames, annual fees, signup promotions, signup bonuses, sign bonus spend requirements, annual credits, rotating categories cash back, rotating category schedule, interest rates, interest rate promo/promo period, airline miles, etc.

Based on the analyzed data, the view layer 34 can present the user with a credit card or combination of credit cards that could have earned the user a maximum cash value return and the actual dollar value of rewards for ail stored credit cards based on the user's financial transactions. In one example, a ranked/ordered listing or other grouping of results including several cards (e.g., including combinations of two, three, or more cards) that are most suitable for the user's/consumer's needs may be provided/outputted. The user further may be able to select, compare, analyze, filter, etc. recommended cards using the user interface 303.

Recommendation results further can include, but are not limited to, payment network, card issuer, card name, application URL, credit card images, personalized recommendations, reviews, ratings, cash converted point rewards, category level cash-back earnings, ranks stored list of high rewards earnings, etc., without departing from the present disclosure.

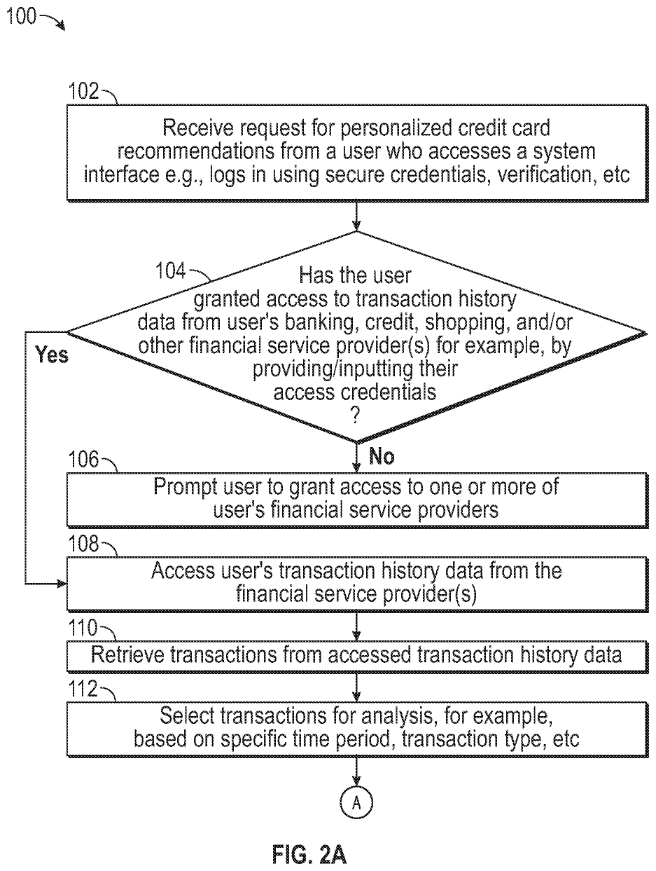

FIGS. 2A and 2B show a flowchart of a method or process 100 for modeling credit card selection based on a user's personal spending or transaction history. As shown in FIG. 2A at Step 102, a request for personalized credit card recommendations can be received from a user, for example, a user who accesses the platform 12 through the view layer 34/user interface 300, e.g., logs in using a secured credentials, verification code, etc.

Upon receipt of the request, a determination can be made as to whether the user has granted access to transaction history data from the user's banking, credit, shopping and other financial service providers, for example, by providing or inputting the user's access credentials into the system interface (Step 104 in FIG. 2A). If the user has not yet granted access to their transaction history data, the user will be prompted to grant access to one or more of the user's financial service providers (Step 106 in FIG. 2A).

If the user has granted access to their financial service provider(s), however, the user's transaction data history may be accessed from the financial service provider(s) (Step 108 in FIG. 2A). For example, the transaction data history can be aggregated and stored in the data repositories 30, e.g., in the aggregator data 301.

Thereafter, at Step 110, transactions will be retrieved from the accessed/aggregated transaction data history. A user further may select predefined transactions for analysis, for example, transactions occurring during a specific time period, having a certain type, etc. (Step 112).

At Step 114, as shown in FIG. 2B, a determination will be made as to whether the selected transactions correspond to predefined or generated categories developed to generally relate to known or defined merchant category codes (MCCs). For example, the categories can be generated by a third-party service provider, based on predefined codes or definitions, and/or based on information received from a credit card company developer network.

Information related to the categories can be stored in, the proprietary data in the data repository, e.g., in local data 300. The particular MCCs that credit card companies use to classify transactions for rewards classification may not always be made publicly available by the credit card companies/merchants and/or may otherwise be generally unknown. As such, the predefined/generated categories can be developed to provide a best estimate for how a credit card company may classify a transaction.

If the selected transactions do not match any predefined or generated categories, additional categories can be generated based upon known information, for example, using statistical analysis, machine learning, etc. (Step 116 in FIG. 2B). These new categories can be stored for future use. In one example, MCCs can also be found through merchant names which can be matched to transaction data that includes “Messy merchant names” along with other identifying information such as location data (latitude, longitude), address, city, state, and zip code. If no categories would be appropriate, however, the transactions can be discarded.

For corresponding categories, transactions can be filtered into the predefined or generated categories (Step 118 in FIG. 2B), and then matched with credit card reward terms of a plurality of credit cards to determine a total rewards value for each credit card of a plurality of credit cards (Step 120 in FIG. 2B).

The rewards value for each credit card of the plurality of credit cards further can be standardized (Step 122 in FIG. 2B). For example, rewards points for each credit card may be standardized into a cash value and the cost or fees of the credit card may be subtracted from this cash value.

Thereafter (at Step 124 in FIG. 2B), the method can include displaying selectable results including a listing or other grouping of each card of the plurality of credit cards and its corresponding standardized rewards value which can allow a user to compare the rewards cards and also select specific rewards cards.

Upon receipt of a selected result, a user can be directed to a website, fillabie form, etc., to allow the user to apply for the corresponding credit card or credit cards (Step 126 in FIG. 2B).

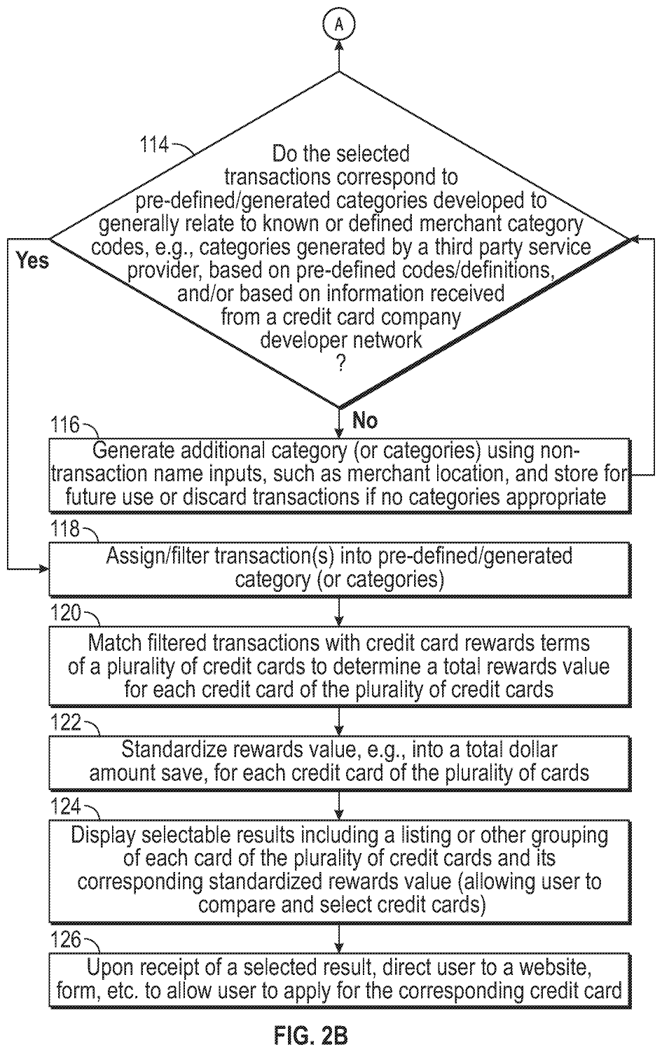

FIG. 3 shows a timeline sequence of events according to aspects of the present disclosure. As shown in FIG. 3, a user can log into the platform (block 202), and when the user enters their credentials for a financial institution, e.g., bank, credit card company, merchant, etc., an access token is created (block 204).

With the access token created, the platform 12 can send a request for transaction data to a transaction aggregator 40, which can be managed by a third party or may include one or more components or engines that are part of the business layer 32 (block 206).

Subsequently, at block 208, the transaction aggregator 40 sends a request out, along with the generated token, to retrieve transaction/spending from the selected financial institution(s) 42. Although FIG. 3 shows that the transaction history is retrieved from a third party financial instruction, the present disclosure is not so limited, and the transaction history can be otherwise received, e.g., the user can upload transaction histories, e.g., receipts, bank statements, etc. or a the system can be embedded or otherwise incorporated with the systems of a financial institution, such as a bank, credit card company, etc.

The transaction aggregator 40 can receive the transaction history (block 210), and provide a notification once the transaction history is ready for analysis (block 212). Thereafter, the transactions can be retrieved to be used in the recommendation process, e.g., using the credit card rule or recommendation engine 302 (block 214).

At block 216, the credit card rule engine can run simulations on a series of selected credit cards using an individual transaction history. The cards included in the result set can be selected by a user or can be selected based on the probability the user will be approved for the cards, for example, as certain cards may not relate to a given user based on factors, such as credit-worthiness or membership restrictions set by cardholder agreements. These qualifiers may be taken into account based on information the user provides before and/or after credit card rewards values are displayed to further filter the set of credit cards shown to a given person. The provision of qualifiers may be manually collected data points or automated when using third party software to help project a user's credit worthiness.

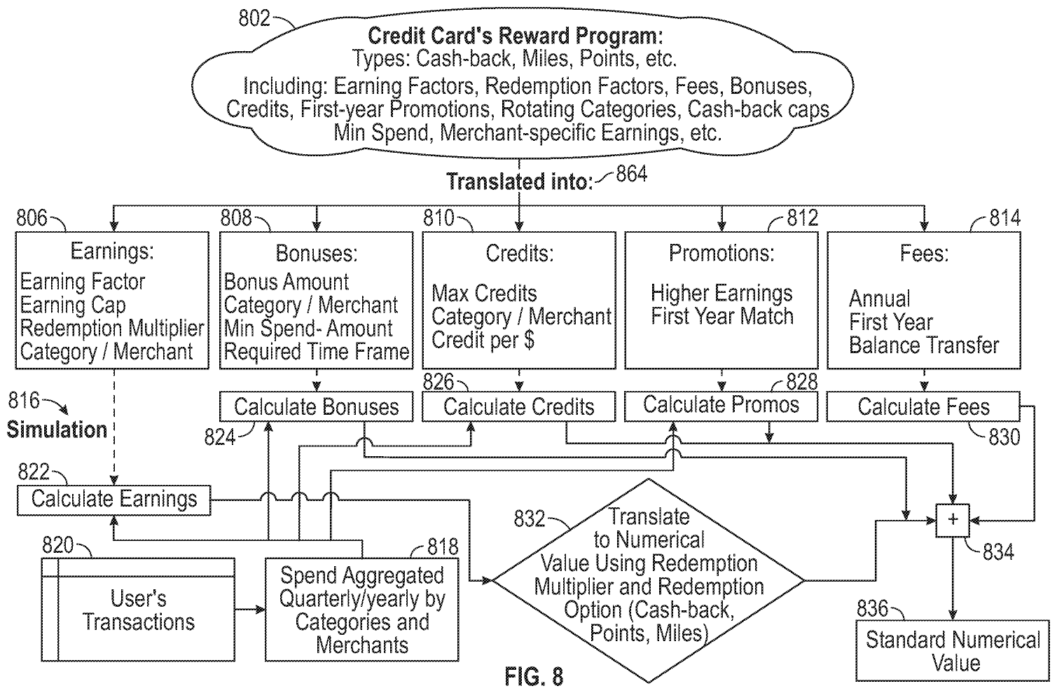

In one example, the credit card rule engine 302 can use an internal store of data and the transactions to simulate cash value earnings for each individual credit card stored in the database (e.g., using an embodiment of “Rewards Standardization” simulation/modeling, such as illustrated in FIG. 8). The credit card rule engine 302 can filter transactions based on information or categories, for example, that relate to MCCs, which are used to classify transactions for assigning rewards, and/or other information used for determining rewards such as business type or merchant name. The simulations output different results for each connected user based on individual spending and how the spending aligns with both earnings and redemptions for categories, business types, and specific merchants.

The credit card rule engine 302 further can be configured to filter transactions from the transaction history into filtered transactions based on the predefined categories (e.g., MCCs or other suitable information), and then match the filtered transactions with credit card reward terms of one or more credit cards to determine a total rewards value for the one or more credit cards or generate card recommendations. Additionally, or in the alternative, the credit card rule engine 302 can employ machine learning (e.g., machine learning algorithms, neural networking, or other supervise learning, statistical models, etc.) to generate the numeric value or card recommendations. The machine learning model can be trained using data/information from previously generated values or card recommendations.

Credit card rewards can include, but are not limited to, cash-back categories, cash-back caps, cash-back earnings, timed earned windows, fees, sign-up promotions, sign-up bonuses, bonus requirements, points, annual credit cards, redemption multipliers, rotating categories, interest rates, promotional interest rates, airline miles, and/or other suitable information or combinations thereof.

At block 220, the engine 302 further can correct for incomplete data by extrapolating out spending to a prescribed time period, such as a full year, to get expected annual rewards earnings.

After all selected cards analyzed, e.g., an estimated value is provided for cards 1 to “n” (Block 222), the results then are aggregated (at block 224) and outputted into an interface that presents customer-friendly, sorted results that help the user make informed financial decisions when selecting a card (block 226).

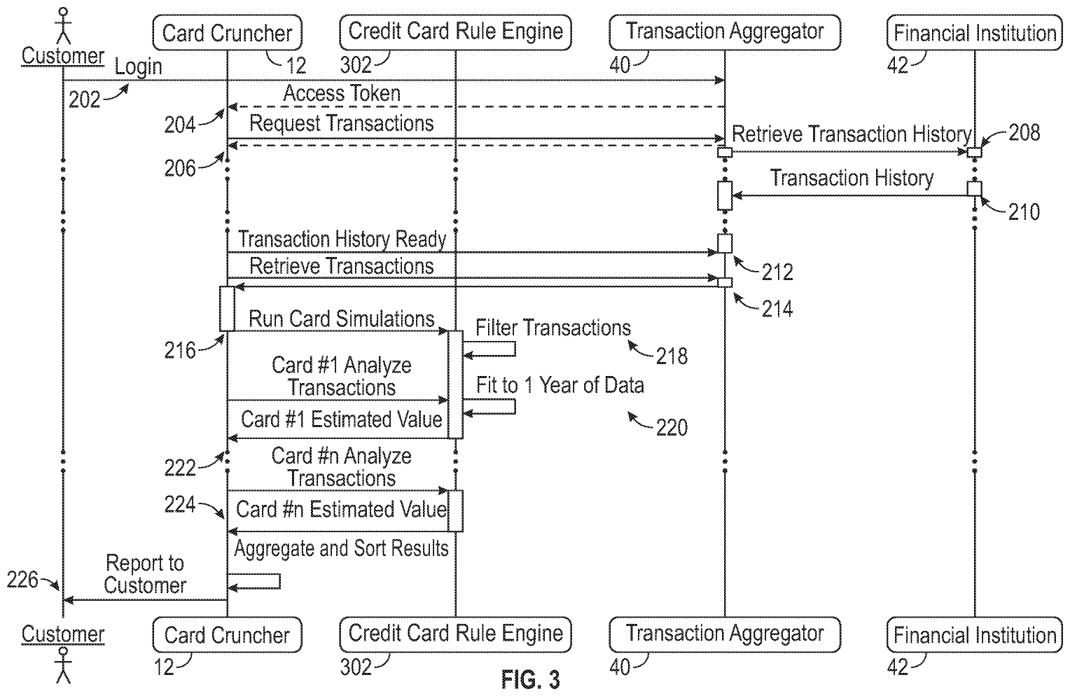

FIG. 4 shows a process or method 400 according to further principles of the present disclosure. As shown in FIG. 4, at Step 402, a connection can be made with a financial aggregator or API, such as a third party aggregator, to return individual transaction data. In addition or alternatively, first party data scraping can be used to source transaction information where a third party aggregator falls short in its coverage of various financial institutions. Additionally, for any transactions that cannot be automatically collected, users have the ability to manually enter in transaction data or category spending information to supplement the automated results.

Then, Step 404, s can be grouped into categories as they pertain to or otherwise relate to MCCs, any complete third-party data, such data can be reconciled with additional API connectors to credit card network providers (e, g., VISA®, MasterCard®, etc.) using transaction data to match by system-normalized merchant name or location, for accurate merchant data.

At Step 406, the categorization of transactions be used to assign credit card rewards programs reward terms to one or more credit cards, but also translating obfuscations such as “points” or “miles” into a dollar value, thus standardizing all rewards between programs.

At Step 408, the system may output relevant information to an end user which includes a total cash value rewards, including all positive cash values, such as points and redemption multiples, and netting those values with negative cash values, such as fees (i.e., negative cash values can be subtracted from positive cash values).

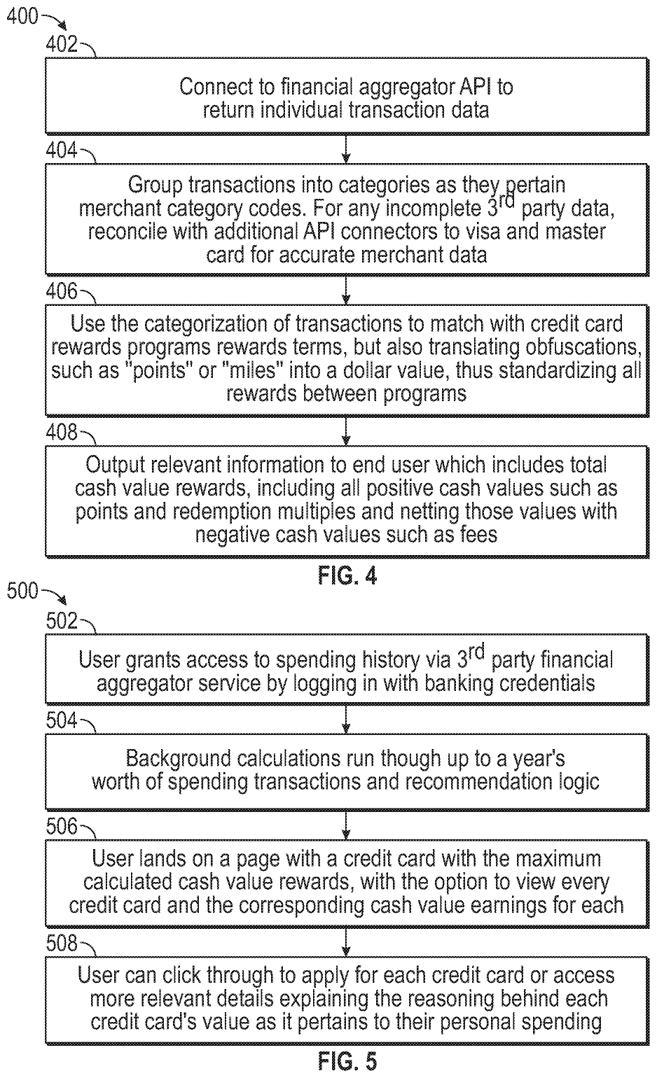

FIG. 5 shows a further method or process 500 in accordance with principles of the present disclosure, In the method shown in FIG. 5, at Step 502, the user ay grant access to their spending history via a third-party financial aggregating service by logging, with their banking credentials.

Then, at Step 504, background calculations may run on a selected historical time period, such as up to one, two, or more years of spending transaction and recommendation logic.

Subsequently, at Step 506, the user will be directed to a page with a credit card with the maximum calculated cash value rewards, with the option to view every credit card and the corresponding cash value earnings for each credit card.

At Step 508, the user can select, e.g., click or otherwise toggle through/between, and apply for each credit card or access more relevant details explaining the reasoning behind each card's value as pertaining to the user's personal spending.

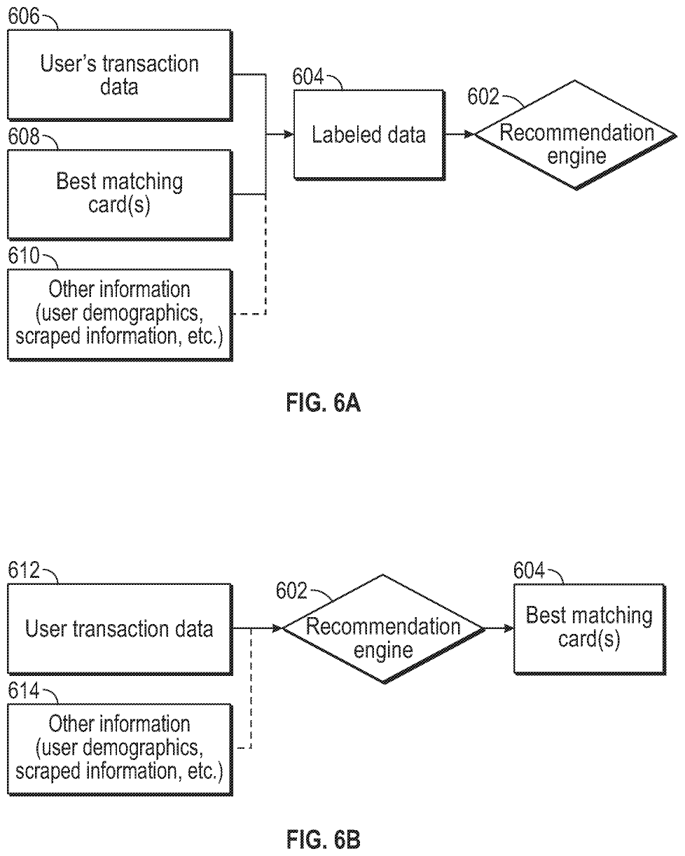

FIGS. 6A and 6B show schematic diagrams for training of and prediction with a credit card recommendation engine 602 that uses machine learning for developing predictions/recommendations or for rewards valuation according to principles of the present disclosure. The recommendation engine 602 can include a machine learning model/algorithm, neural network, other supervised learning model, etc. though other statistical models, algorithms, etc. can be used without departing from the present disclosure.

As shown in FIG. 6A, a machine learning model for the recommendation engine 602 can be trained using labeled data 604, including user transaction data 606 and best matching card(s) 608, as well as other information 610 (such as user demographics information, information scraped from third party sites, etc.) to predict the best matching card(s) for any given user transaction data and/or other information.

The best matching card component 608 can include sets of predicted or selected best matching cards calculated based on given/prescribed user transaction data 606. More specifically, the best snatching card component 608 can include cards matched to or otherwise corresponding with specific user transaction data 606 (e.g., including cards or combinations previously matched transaction data of previous users as determined according to the methods/processes described herein or including other suitable training data of cards or combinations match to transection data). The recommendation credit card engine 602 can be applied to the labeled data 604 (e.g., sets of user transaction data 606 and corresponding best matching cards or card combinations 608) to train the machine learning model to generate one or more recommendations or predictions (e.g., card recommendations, card combination recommendations, reward values, etc.).

In addition, labeled data 604 (e.g., including cards matched to other user transaction data or other suitable testing data) can be used to test the accuracy/performance of the machine learning model. In some variations, the results of the machine learning model can be compared against known results of the labeled data 604 to determine whether the machine learning model provides/generates the most suitable card or card combination recommendation, e.g., within a prescribed threshold of accuracy or confidence interval.

Upon training of the machine learning model, e.g., when the machine learning model achieves a prescribed level of accuracy, confidence level, etc., the recommendation engine 602 can be used to provide results 604 including a recommended card or cards, combinations of recommended cards (e.g., combinations of two or three cards that would maximize the user's rewards value), reward values, etc. based on new data obtained or received by one or more modules, components, information extractors, etc. 612, 614.

Component, module, information extractor, etc. 612 can obtain or receive user transaction data. (such as purchase/transaction histories, e.g., obtained, from APIs, scraped from third-party websites, etc.; spending trends; the user's card types; card usage, etc.) and provide the user transaction data to the trained recommendation engine 602. Component, module, information extractor, etc. 614 can obtain/receive other/additional information, such as user demographics, (e.g., age, sex, region, nationality, etc. information inputted by the user) and provide the other/additional information to the trained recommendation engine. The other/additional information also can include other suitable information, such as merchant information, e.g. MCCs or other transaction identifiers; credit card information, e.g., card holder agreements, contracts, etc.; information scraped from third party sites, e.g., items in a checkout/cart, information related to products/services a user is likely to purchase; etc., without departing from the present disclosure.

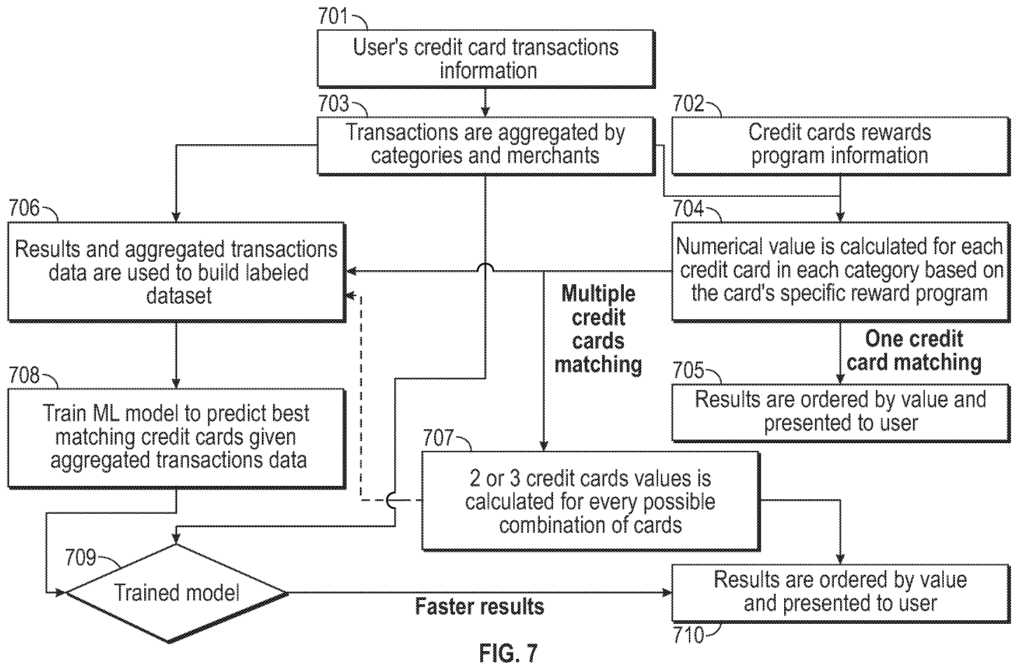

Upon receiving the information from one or more components 612/614, the recommendation engine 602 can apply a resultant trained machine learning model 709 (FIG. 7) to predict result/recommendation, e.g., a rank of ordered results set to output one card and/or two or three or more card combinations of credit cards that would best suit an individual's spending. Thereafter, each time the recommendation engine used, the related transactions can be added to the labeled data 604 for further training and/or updating of the machine learning model, as more cards are added and more users make use of the system. The machine learning model thus can continuously run over increasing or multiple data sets of user transaction information, matched cards or card combinations, or other/additional information to constantly improve the speed and accuracy of the outputted results/recommendations.

FIG. 7 shows the process of analyzing a user's transactions) and matching credit card(s) with a highest value to a user using machine learning in accordance with principles of the present disclosure. This process can be performed by the recommendation engine 602 or other components of the present disclosure. At 701, a user's transaction information is received or otherwise obtained (e.g., from a user's financial institution, APIs, etc.).

Then, at 702, credit cards rewards program information is obtained or received (e.g. scraped from third party sites obtained from credit card agreements, contracts, etc., and, at 703, the user's transactions can be aggregated by categories and merchants. For example, the user's transactions can be filtered based on MCCs and the filtered transactions can be matched with terms of a credit card rewards program.

Furthermore, at 704, a cash value is given of the predefined categories, e.g., a numerical value is calculated for each credit card in each category based on the card's specific ward program.

For single card matching, results are ordered by value and presented to the user(s) (at 705). For multiple card matching, a combination, e.g., two or three or more, of credit cards value is calculated for every possible combination (at 707), and the highest combined cash value of the cards is calculated based on the category's values, and for each category, the higher cash value is used. The result can include a ranked list of multiple matching credit cards.

At 706, the aggregated transaction data, together with the ranked list is used to create/build a labeled data set. For example, the data set can, take the form of {X: Y} where X is the aggregated transaction data and Y is the resulted multiple matching credit cards, e.g., ranked by value.

In addition, the labeled data then is used to train and/or update the machine learning model (at 708). Once the machine learning model has been trained/developed to a point where operation of the trained model (709) has a confidence level or accuracy above a prescribed threshold or percentage, the trained model 709 can be used directly, bypassing the card value simulation operation for subsequent credit card recommendation operations based on user's transactions. For example, as further shown in FIG. 7, the user 's credit card transaction information is obtained/received (at 701), and transactions therefrom are aggregated based on categories and merchants (at 703). Then, the process moves directly to the trained machine learning model 709 to provide the results/recommendations, which can be ordered by value and presented to the user. These results/recommendations also can be used to further train/update the machine learning model to continuously improve the speed and accuracy thereof.

Furthermore, the trained machine learning model can be (at least periodically) tested or checked and, if it is determined that the results/recommendations of the machine learning model falls below a prescribed accuracy threshold or level of confidence, or users are otherwise not taking the recommendations provided by the model, the process flow can return to executing the steps of 702, 704, 705, and 707 to generate recommendations or updated training data to improve accuracy, confidence level, etc. of the results.

FIG. 8 shows a diagram for rewards standardization in accordance with principles of the present disclosure. As shown at 802, credit card rewards are generally split into three categories that are assigned based on the redemption method for value earned through the rewards programs. The common rewards types include Points, Miles, and Cash Back. While all cash back cards can be redeemed for a cash equivalent, some points and miles cards cannot, which can necessitate use of user spending to accurately quantify cash value for the individual. In addition, beyond the redemption types, there are a number of variables that comprise the value offered through credit cards and their rewards programs. As shown in FIG. 8, at 802, such variables can include, but are not limited to, earnings factors, redemption factors, fees, bonuses, credits, first-year promotions, rotating categories, cash-back caps, minimum spending requirements, merchant-specific earnings, etc.

Additionally, card rewards categories can be ted to various value categories (as shown at 804), including earnings 806 (e.g., including earning factor, earning cap, redemption multiplier, category/merchant earnings, etc.); bonuses 808 (e.g., including bonus amount, category/merchant bonuses, minimum spent amounts/time frames, etc.); credits 810 (e.g., such as max credits, category merchant credits, credits per amount spent, etc.); promotions 812 (e.g., including higher earnings promotions, first year matches, etc.); as well as fees 814 (e.g., including annual, first year, balance transfer fees, etc.).

With all of the aforementioned values having contingencies on a user's spending profile, the associated earnings 806, bonuses 808, credits 810, promotions 812, and fees 814 are cross-referenced (e.g., at simulation 816) to user spending data which helps glean both direct and indirect insights to calculate results and inform the machine learning model.

As shown at 818, the user transactions 820, including user spending data, are aggregated quarterly and yearly as needed and is assigned to both system-defined merchants and categories to fit the end points for the structure of each credit card's rewards structure.

Accordingly, a standardized value, standard dollar amount, associated with earnings can be calculated at 822; a standardized value, e.g., standard dollar amount, associated with bonuses can be calculated at 824; a standardized value, e.g., standard dollar amount, associated with credits can be calculated at 826; a standardized value, dollar amount, associated with promos can be calculated at 828; and fees can be calculated at 830.

At 832, calculated earnings, further are adjusted to account for applicable redemption multipliers and/or noncash redemption options, such as points and miles, as they pertain to a user's spending profile.

Thereafter, at 834, all of the calculated values are sun med to create a single standard numerical value 836 for each card in the system.

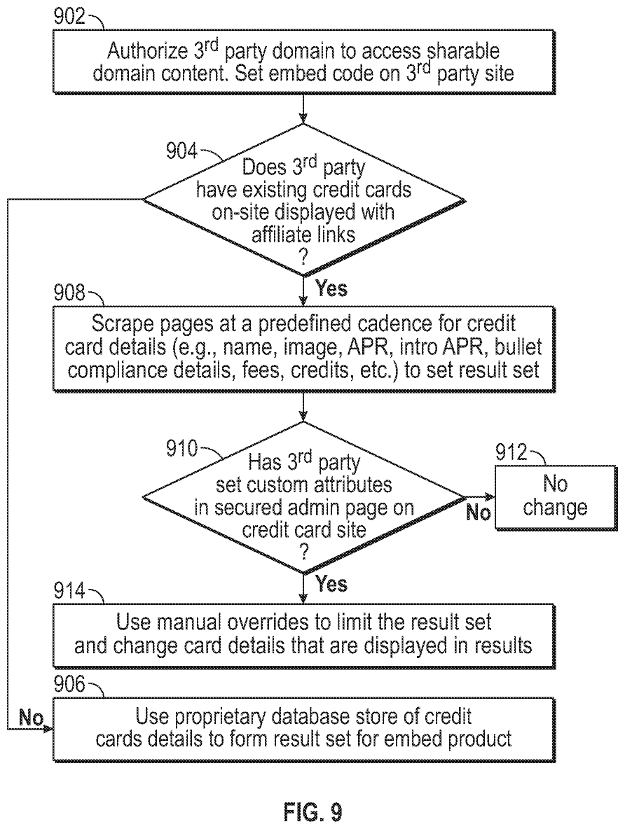

FIG. 9 shows a floe diagram for a third party application that comes in the form of an embeddable widget or browser extension (e.g., that interfaces with a web browser, such as Google Chrome®, Mozilla Firefox®, Microsoft Internet Explorer®, etc.), that enables/facilitates scraping or other information gathering from websites and displaying credit card recommendations to users across internet domains.

As shown at 902, a third party domain(s) can authorize access to shareable domain content, for example, an embed code can be set on a third party site that enables the system to be displayed. In addition, or in an alternative, users tray install a browser extension, thus granting access to the user's browsing activity.

At 904, it then can be determined whether the third party has existing credit cards site, e.g., that are displayed with affiliate links. If the third party does not have any existing credit cards on site, a propriety data store of credit card details can be used to form a result set for the embedded product (as shown at 906).

If the third party site does have existing credit cards on site, however, various pages of the site can be scraped at a predefined cadence for credit card details (such as, e.g., name, image, APR, introductory APR, bullet compliance details, fees, credits, etc.) to set/generate result set (at 908).

Furthermore, the system can give access to the third party allowing it to set custom attributes in a secure admin page to customize results of the embed product (at 910). For example, a third party that makes use of the embed product may select which details and brands should be included, excluded, or modified from the result set. If no customizations are applied, no change will be made to the generated result set (as shown at 912).

However, if changes are applied, the manual overrides can limit the result set and card details that are displayed in the results (as shown at 914).

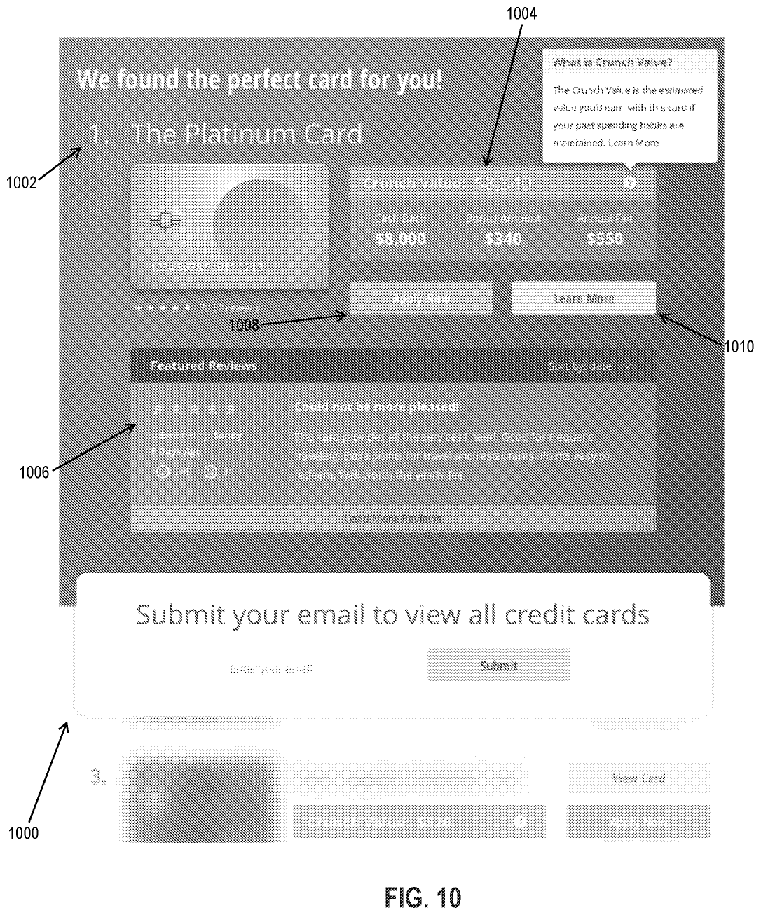

FIG. 10 shows an exemplary screen 1000 of an application or program of the systems/methods of the present disclosure. As shown in FIG. 10, the screen 1000 displays the ranking of the card(s) 1002, a standardized cash rewards value 1004 (e.g., the estimated rewards value a user will obtain with the card based on the user's past spending habits), as well as featured customer reviews 1006 of the displayed card. The screen 1000 further includes an icon/area 1008 that is selectable to allow a user to apply for the displayed card (e.g., that directs the user to a website or application of the card provider), as well as an icon 1010 that is selectable to provide a user with additional information related to the card (e.g., terms, restrictions, etc. in a pop-up window or new window, screen, etc.).

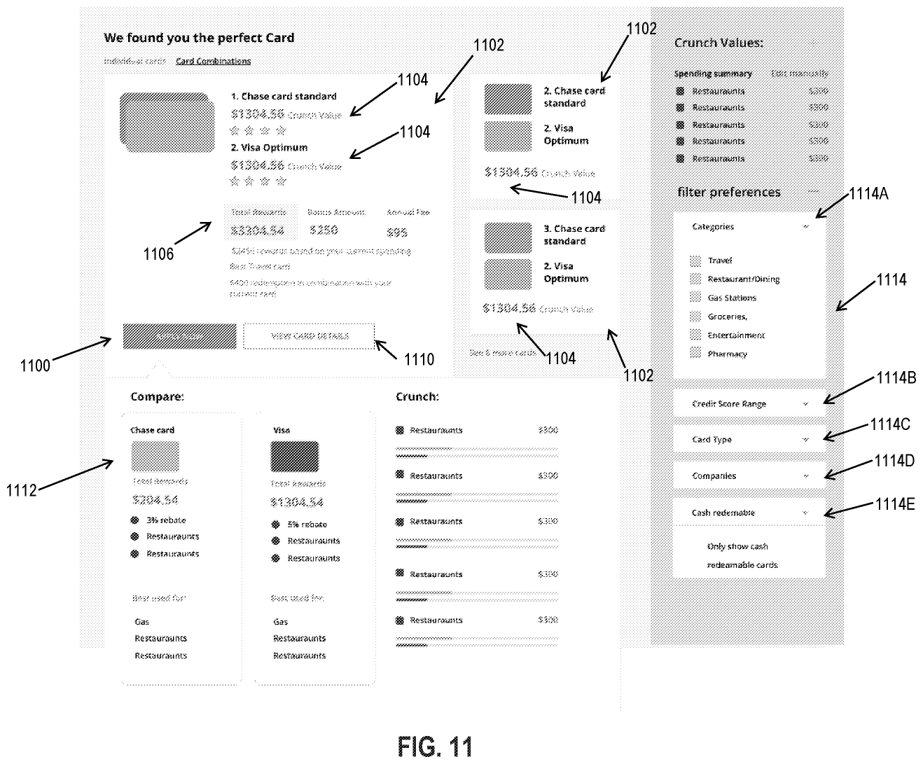

FIG. 11 shows an additional exemplary screen 1100 of an application or program of the systems/methods in accordance with the present disclosure. As shown in FIG. 11 listings or groupings of results/recommendations 1102 can be provided for recommended card combinations. The groupings of results/recommendations 1102 can be ranked, e.g., 1, 2, 3, etc., according to the determined standardized rewards value, shown in FIG. 11 as a dollar value at 1104. The standardized rewards value 1104 for each card, as well as a total rewards value 1106 for a recommended combination of cards can be shown along with the groupings 1102. A selectable icon 1108 further can be provided (e.g., in connection with the top card combination) to direct users to a website, application, form etc. that allows for users to apply for one or more of the recommended cards, such as credit card provider, bank, or other third party websites or applications. Others selectable icons, such as 1110, also can be provided to allow a user to view card details/information (e.g., terms, agreements contracts, reviews, etc.). The screen 1100 additionally can provide a window or area 1112 that shows card comparisons, e.g., including the total rewards value and other information, such as best used for categories, rebate rates, etc. The screen 1100 further can provide a window or area 1114 that allows for manual editing or filtering of preferences, for example, filtering based on categories such as travel, restaurant for dining, gas stations, groceries, entertainment, pharmacy, etc. Preferences further can be filtered based on credit score ratings, card type, companies, cash redeemable values, etc., or other suitable information or categories. Such a window/area 1114 can include pull/drag down lists 1114 A-E that can be selected/activated so as to be expended/retracted, which lists 1114 A-F, can include selectable items, such as, check-boxes or other selectable elements, that allow for selection and deselection of filter preferences.

The foregoing description generally illustrates and describes various embodiments of the present invention. It will, however, beunderstood by those skilled in the art that various changes and modifications can be made to the above-discussed construction of the present invention without departing from the spirit and scope of the invention as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present invention. It therefore will be understood by those skilled in the art that while the present invention has been described above with reference to preferred embodiments, numerous variations, modifications, and additions can be made thereto without departing from the spirit and scope of the present invention as set forth in the following claims. Accordingly, various features and characteristics of the present invention as discussed herein may be selectively interchanged and applied to other illustrated d non-illustrated embodiments of the invention, and numerous variations, modifications, and additions further can be made thereto without departing from the spirit and scope of the present invention as set forth in the appended claims.

What is claimed is:

1. A system for credit card selection personalized in view of a user's spending transactions, comprising:
one or more processors and a memory having stored therein a plurality of instructions that when executed by the one or more processors implement:
a transaction aggregator configured to retrieve a transaction history of the user from one or more selected financial institutions; and
a credit card recommendation engine configured to:
receive the fir history from the transaction aggregator,
filter a plurality of transactions of the transaction history into one or more filtered transaction sets based on predefined categories, and
match the filtered transaction sets with credit card reward terms of one or more credit cards to determine a rewards value or a recommendation for the one or more credit cards.

2. The system of claim 1, wherein one or more of the predefined categories comprise merchant category codes.

3. The system of claim 1, wherein the predefined categories further comprise estimated merchant category codes.

4. The system of claim 1, wherein the credit card reward terms include cash-back categories, cash-back caps, cash-back earnings, timed earned windows, fees, sign-up promotions, sign-up bonuses, bonus requirements, points, annual credit card fees, redemption multipliers, rotating categories, interest rates, promotional interest rates, airline miles, or combinations thereof.

5. The system of claim 1, wherein the transaction history includes one or more historical credit card or bank statements of the user, and wherein the plurality of transactions comprise information related to a merchant name, merchant category, or dollars spent.

6. The system of claim 1, wherein the rewards value includes a total dollar amount saved or earned by the one or more credit cards.

7. The system of claim 1, wherein one or more credit cards are selected based upon a probability the user will be approved for the selected one or more cards.

8. The system of claim 1, wherein the credit card recommendation engine further determines the rewards value or recommendation based at least in part on information that is scraped from one or more third-party websites.

9. The system of claim 1, wherein the credit card recommendation engine further comprises reviewing a plurality of available credit cards and determining a set or suitable credit cards for the user based at least in part on the transaction history.

10. A method for personalized credit card selection based on a user's personal spending, comprising:
receiving a request for personalized credit card recommendations from the user;
accessing one or more transaction histories of the user and retrieving a plurality of transactions from the one or more transaction histories;
filtering the plurality of transactions into filtered transactions based on one or more predefined categories;
matching the filtered transactions with credit card reward terms of at least one credit card and determining a rewards value or a recommendation for the at least one credit card; and
displaying the rewards value or for the at least one credit card.

11. The method of claim 10, wherein the credit card reward terms include cash-back categories, cash-back caps, cash-back earnings, timed earned windows, fees, sign-up promotions, sign-up bonuses, bonus requirements, points, annual credit card fees, redemption multipliers, rotating categories, interest rates, promotional interest rates, airline miles, or combinations thereof.

12. The method of claim 10, wherein the transaction history includes one or more historical credit card or bank statements of the user.

13. The method of claim 10, further comprising standardizing the rewards value into a standardized cash value.

14. The method of claim 10, wherein the predicted category codes comprise one or more merchant category codes.

15. The method of claim 14, further comprising:
if one or more of the transactions of the plurality of transactions do not correspond to merchant category codes, generating additional categories to correspond to the one or more transactions that do not correspond to the merchant category codes.

16. The method of claim 15, wherein the additional categories are generated using machine learning.

17. The method of claim 10, further comprising:
directing the user to a website that allows the user apply for the one or more credit card.

18. A system, comprising:
a processor and memory having stored therein a plurality of instructions that when executed by the processor implement:
at least one component configured to receive or obtain user purchase or transaction information; and
a credit card recommendation engine including a machine learning model that is configured to receive the purchase or transaction information from the at least one component, and determine a credit card recommendation of one or more individual credit cards or a combination of credit cards.

19. The system of claim 18, wherein the machine learning model is trained by aggregating purchase or transaction information from previous users by categories or merchants, and determining a numerical value for one or more selected credit cards based on rewards programs of the one or more selected credit cards and the purchase or transaction information from previous users.
